(19) United States
(12) Patent Application Publication
(10) Pub. No.: US 2017/0073786 A1
(43) Pub. Date: Mar. 16, 2017

(54) HEAT TREATMENT APPARATUS

(71) Applicants: IHI Corporation, Tokyo (JP); IHI Machinery and Furnace Co., Ltd., Tokyo (JP)

(72) Inventors: Kazuhiko KATSUMATA, Inuyama-shi (JP); Kaoru ISOMOTO, Tokyo (JP); Takahiro NAGATA, Kamo-gun (JP); Akira NAKAYAMA, Hikari-shi (JP); Yuusuke SHIMIZU, Gifu-shi (JP); Gen NISHITANI, Kakamigahara-shi (JP)

(73) Assignees: IHI Corporation, Tokyo (JP); IHI Machinery and Furnace Co., Ltd., Tokyo (JP)

(21) Appl. No.: 15/343,355

(22) Filed: Nov. 4, 2016

Related U.S. Application Data
(63) Continuation of application No. PCT/JP2015/069421, filed on Jul. 6, 2015.

(30) Foreign Application Priority Data
Jul. 7, 2014 (JP) 2014-139630

(51) Int. Cl. C21D 9/00; F27B 5/14; F27B 5/08; F27D 1/18; F27D 1/00

(52) U.S. Cl. CPC C21D 9/0043; F27D 1/1808; F27D 1/0003; F27B 5/08; F27B 5/14

(57) ABSTRACT

A heat treatment apparatus includes: a heat treatment chamber that performs heating treatment for a treatment object thereinside; and a thermal insulator disposed inside the heat treatment chamber and surrounding a receiving area for the treatment object. The heat treatment chamber includes a side wall portion and a lid portion configured to be attachable to and detachable from the side wall portion. The thermal insulator includes a ceiling disposed on the inside of the lid portion. The ceiling includes a thermal insulator lid that is at least part of the ceiling and is united to the lid portion.

### CROSS-REFERENCE TO RELATED APPLICATIONS

This application is a Continuation Application based on International Application No. PCT/JP2015/069421, filed Jul. 6, 2015, which claims priority on Japanese Patent Application No. 2014-139630, filed Jul. 7, 2014, the contents of which are incorporated herein by reference.

### TECHNICAL FIELD

The present disclosure relates to a heat treatment apparatus.

### BACKGROUND

As a heat treatment apparatus that performs heating treatment for a metal material serving as a treatment object, a multi-chamber heat treatment apparatus is known (for example, refer to Patent Document 1). The multi-chamber heat treatment apparatus includes a heating chamber (a heat treatment chamber) in which the treatment object is contained, and a heater provided inside the heating chamber heats the treatment object, whereby the heating treatment is performed. In addition, the inside of the heating chamber is provided with a thermal insulator surrounding a space in which the treatment object is disposed.

Patent Documents 2 to 4 also disclose heat treatment apparatuses that perform heating treatment for a treatment object inside a heating chamber including a thermal insulator.

### DOCUMENT OF RELATED ART

### Patent Document

[Patent Document 1] Japanese Unexamined Patent Application, First Publication No. 2012-13341

[Patent Document 2] Japanese Unexamined Patent Application, First Publication No. H10-267547

[Patent Document 3] Japanese Unexamined Patent Application, First Publication No. H05-018671

[Patent Document 4] Japanese Unexamined Patent Application, First Publication No. 2003-336972

### SUMMARY

### Technical Problem

A mounting table on which the treatment object is mounted, a maffle plate used for uniformly performing heating treatment for the treatment object and the like are disposed in the space surrounded by the above-described thermal insulator. Accordingly, members disposed in the space surrounded by the thermal insulator, the inner wall surface of the thermal insulator or the like has to be periodically inspected. However, when such inspections are carried out, the thermal insulator has to be disassembled after the heating chamber is disassembled, and thus the work thereof may become complicated.

The present disclosure has been made in view of the above problems, and an object thereof is to provide a heat treatment apparatus in which a thermal insulator surrounding a receiving area for a treatment object is provided inside a heating chamber and work such as inspection of the inside of the thermal insulator can be easily performed.

### Solution to Problem

The present disclosure adopts the following configurations serving as means of solving the above problems.

A first aspect of the present disclosure is a heat treatment apparatus including: a heat treatment chamber that performs heating treatment for a treatment object thereinside; and a thermal insulator disposed inside the heat treatment chamber and surrounding a receiving area for the treatment object. The heat treatment chamber includes a heat treatment chamber body and a lid portion configured to be attachable to and detachable from the heat treatment chamber body. The thermal insulator includes a thermal insulator body and a thermal insulator lid configured to be attachable to and detachable from the thermal insulator body. In addition, the thermal insulator lid is united to the lid portion.

A second aspect of the present disclosure is that in the heat treatment apparatus of the first aspect, part of the heat treatment chamber body is a side wall portion of the heat treatment chamber. The lid portion is configured to be attachable to and detachable from an upper part of the side wall portion. The thermal insulator includes a ceiling disposed on the inside of the lid portion of the heat treatment chamber. In addition, the thermal insulator lid is at least part of the ceiling.

A third aspect of the present disclosure is that in the heat treatment apparatus of the first aspect, the thermal insulator lid is formed into a plate shape whose edge surface has a tapered surface. In addition, the thermal insulator body includes a frame having a tapered surface that contacts the edge surface of the thermal insulator lid so as to overlap the edge surface.

A fourth aspect of the present disclosure is that in the heat treatment apparatus of the second aspect, the thermal insulator lid is formed into a plate shape whose edge surface has a tapered surface. In addition, the ceiling includes a frame having a tapered surface that contacts the edge surface of the thermal insulator lid so as to overlap the edge surface.

A fifth aspect of the present disclosure is that in the heat treatment apparatus of the third or fourth aspect, the thermal insulator lid is formed into a circular plate shape whose circumferential surface has the tapered surface.

A sixth aspect of the present disclosure is the heat treatment apparatus of any one of the first to fifth aspects further including a heater disposed inside the heat treatment chamber and configured to be attachable to and detachable from the lid portion and the thermal insulator lid.

### Effects

According to the present disclosure, at least part of the ceiling of the thermal insulator surrounding the receiving area for the treatment object is the thermal insulator lid, and the thermal insulator lid is united with the lid portion of the heating chamber. In addition, the lid portion of the heating chamber is configured to be attachable to and detachable from the side wall portion of the heating chamber. Therefore, when the lid portion of the heating chamber is detached from the side wall portion, the thermal insulator lid can be detached at the same time of the detachment of the lid portion. Consequently, it is possible to perform inspections or the like of the inside of the thermal insulator only through the detaching work of the lid portion of the heating chamber. Thus, according to the present disclosure, it is possible to easily perform work such as inspection of the inside of the thermal insulator in the heat treatment apparatus in which the thermal insulator surrounding the receiving area for the treatment object is provided inside the heating chamber.

### BRIEF DESCRIPTION OF DRAWINGS

FIG. 1 is a vertical cross-sectional view showing a schematic configuration of a heat treatment apparatus of an embodiment of the present disclosure.

FIG. 2 is a vertical cross-sectional view showing a schematic configuration of a lid section included in the heat treatment apparatus of the embodiment of the present disclosure.

FIG. 3 is a vertical cross-sectional view showing a schematic configuration of a heater section included in the heat treatment apparatus of the embodiment of the present disclosure.

FIG. 4 is a vertical cross-sectional view showing a state where the lid section is detached from a base section in the heat treatment apparatus of the embodiment of the present disclosure.

FIG. 5 is a vertical cross-sectional view showing a state where the lid section and the heater section are detached from the base section in the heat treatment apparatus of the embodiment of the present disclosure.

### DESCRIPTION OF EMBODIMENTS

Hereinafter, a heat treatment apparatus of the present disclosure is described with reference to the drawings. In the following drawings, the scale of each member is appropriately changed in order to show each member in a recognizable size.

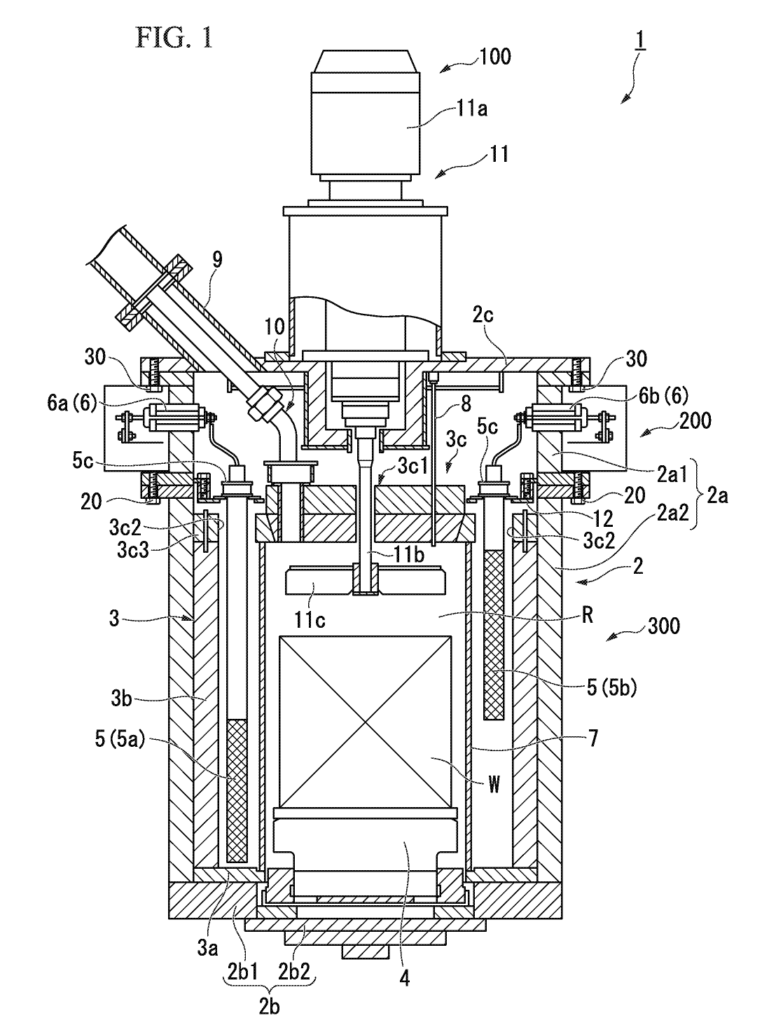

FIG. 1 is a vertical cross-sectional view showing a schematic configuration of a heat treatment apparatus 1 of an embodiment of the present disclosure. The upper sides of FIGS. 1 to 6 show the upper side of the apparatus in the vertical direction. The heat treatment apparatus 1 of this embodiment is an apparatus that performs heating treatment for a treatment object W and as shown in FIG. 1, includes a heating chamber 2 (a heat treatment chamber), a thermal insulator 3, a mounting table 4, heaters 5, a power supplier 6, a maffle plate 7, a gas supplier 8, a first exhaust pipe 9, a second exhaust pipe 10 and a stirrer 11.

The heating chamber 2 is a vertically placed container that is formed into an approximately cylindrical shape and whose central axis extends in the vertical direction. In the heating chamber 2, an approximately cylindrical side wall portion 2a (a heat treatment chamber body) is provided with a bottom portion 2b (the heat treatment chamber body) and a lid portion 2c, whereby the inside of the heating chamber 2 becomes a closed space. That is, the heating chamber 2 includes the side wall portion 2a, the bottom portion 2b and the lid portion 2c and is configured to perform heating treatment for the treatment object W thereinside. The thermal insulator 3, the mounting table 4, the heaters 5, the milk plate 7 and the like are accommodated in the closed space, namely the inside of the heating chamber 2. In this embodiment, the side wall portion 2a and the bottom portion 2b correspond to the heat treatment chamber body. In other words, part of the heat treatment chamber body is the side wall portion 2a of the heating chamber 2.

The side wall portion 2a is formed of an upper part 2a1 and a lower part 2a2. As shown in FIG. 1, the upper part 2a1 and the lower part 2a2 are fastened together using bolts 20 and are configured to be detachable from each other. The bottom portion 2b includes a circular annular bottom frame 2b1 and a bottom body 2b2 that is detachably attached to a central opening of the bottom frame 2b1 and air-tightly closes the central opening. The bottom body 2b2 is detachably attached to the bottom frame 2b1 using fastening screws or the like. The bottom body 2b2 is formed and disposed so as to contact the bottom frame 2b 1. The bottom body 2b2 functions as an opening-and-closing member (an opening-and-closing door) used for loading and unloading the treatment object W into and from the inside of the heating chamber 2. As shown in FIG. 1, the lid portion 2c is fastened to the side wall portion 2a (the upper part 2a1) using bolts 30 and is configured to be attachable to and detachable from the side wall portion 2a. That is, the lid portion 2c is configured to be attachable to and detachable from the upper part of the side wall portion 2a.

The thermal insulator 3 includes a lower thermal insulator 3a (a thermal insulator body), a side thermal insulator 3b (the thermal insulator body) and an upper thermal insulator 3c (a ceiling). The lower thermal insulator 3a is formed into a circular annular shape provided on the top of the bottom frame 2b1. The side thermal insulator 3b is attached to the inner wall of the side wall portion 2a (the lower part 2a2) of the heating chamber 2. That is, the side thermal insulator 3b is also formed into a cylindrical shape. The upper thermal insulator 3c is disposed on the inner side of the lid portion 2c of the heating chamber 2 (that is, is disposed under the lid portion 2c). The upper thermal insulator 3c includes a thermal insulator lid 3c1 provided in the central part of the upper thermal insulator 3c, and an annular frame 3c3 (the thermal insulator body) surrounding the thermal insulator lid 3c1. In this embodiment, the lower thermal insulator 3a, the side thermal insulator 3b and the frame 3c3 correspond to the thermal insulator body. In other words, the thermal insulator body includes the frame 3c3. The thermal insulator lid 3c1 is at least part of the upper thermal insulator 3c and is integrally connected to the lid portion 2c of the heating chamber 2 through connecting members (the gas supplier 8 and the second exhaust pipe 10 described below). In addition, the thermal insulator lid 3c1 is configured to be attachable to and detachable from the frame 3c3. The thermal insulator lid 3c1 is formed into a circular plate shape whose circumferential surface (peripheral edge surface) has a tapered surface that diagonally faces downward and radially outward. That is, the circumferential surface of the thermal insulator lid 3c1 has a tapered surface whose diameter gradually decreases downward. The thermal insulator lid 3c1 of this embodiment is configured of two plate-shaped thermal insulators piled up in the vertical direction, and the above tapered surface is provided in the peripheral edge surface of the plate-shaped thermal insulator positioned below. It is to be noted that the present disclosure is not limited to this configuration, the thermal insulator lid 3c1 may be configured of one plate-shaped thermal insulator, and the above tapered surface may be provided in at least part of the peripheral edge surface of this plate-shaped thermal insulator. The frame 3c3 has a tapered surface that contacts the circumferential surface of the thermal insulator lid 3c1 so as to overlap the circumferential surface, and the tapered surface diagonally faces upward and radially inward. That is, the inner circumferential surface of the frame 3c3 has a tapered surface whose diameter gradually increases upward and which can contact the circumferential surface (the peripheral edge surface) of the thermal insulator lid 3c1. The thermal insulator lid 3c1 is configured to close an opening provided in the central part of the frame 3c3 by being supported by the frame 3c3 in a state where the circumferential surface of the thermal insulator lid 3c1 contacts the tapered surface of the frame 3c3 so as to overlap the tapered surface. In addition, the frame 3c3 is provided with through-holes 3c2 disposed around the thermal insulator lid 3c1, and the heaters 5 are inserted into the through-holes 3c2. In this embodiment, since twelve heaters 5 are provided as described below, twelve through-holes 3c2 are annularly disposed in the frame 3c3 around the thermal insulator lid 3c1. The thermal insulator 3 may be formed by overlapping a thermal insulation material and a ceramic board with each other, and the thermal insulation material is formed of, for example, a ceramic fiber board.

The mounting table 4 is disposed on the top of the bottom body 2b2, and the treatment object W is placed on the mounting table 4. When the bottom body 2b2 is detached from the bottom frame 2b1, the mounting table 4 is moved together with the bottom body 2b2 and is taken out of the heating chamber 2.

The heaters 5 are electric heaters that generate heat by being energized. In this embodiment, the heaters 5 include lower heaters 5a having long bodies and upper heaters 5b having short bodies. A lower end portion (a portion including the lower end) of the body of the lower heater 5a is a heat-generating area, and the lower heater 5a heats the lower section of a receiving area R for the treatment object W. A lower end portion (a portion including the lower end) of the body of the upper heater 5a is a heat-generating area, and the upper heater 5a heats the upper section of the receiving area R for the treatment object W.

The upper parts of the heaters 5 are provided with flanges 5c. An annular supporting member 12 disposed above the frame 3c3 is fixed to the side wall portion 2a, and the flanges 5c are supported by the supporting member 12, whereby the heaters 5 are suspended and supported. The heaters 5 are inserted through the through-holes 3c2 from above the thermal insulator 3 into the space enclosed by the thermal insulator 3. That is, the heaters 5 are disposed inside the heating chamber 2.

The power supplier 6 is a device that supplies electric power to the heaters 5 and is connected to each heater 5 through a heat-resistant electrical wire. In this embodiment, the power supplier 6 is configured of a lower heater-power supplier 6a and an upper heater-power supplier 6b. The lower heater-power supplier 6a supplies electric power to all the lower heaters 5a, and the upper heater-power supplier 6b supplies electric power to all the upper heaters 5b.

The maffle plate 7 is a cylindrical member that is disposed along the side wall portion 2a with a constant gap therebetween so that the central axis of the maffle plate 7 is disposed at approximately the same position as the central axis of the side wall portion 2a. The maffle plate 7 is formed of a refractory having excellent thermal conductivity. The maffle plate 7 is provided at a position closer to the center of the heating chamber 2 than the heaters 5, and an arrangement space for the heaters 5 is formed between the maffle plate 7 and the side wall portion 2a. The upper thermal insulator 3c (the frame 3c3) is disposed on the upper end of the maffle plate 7. A space surrounded by the maffle plate 7 corresponds to a space in which the treatment object W is contained during heating treatment. Hereinafter, this space is referred to as the receiving area R. The thermal insulator 3 of this embodiment is disposed inside the heating chamber 2 so as to surround the receiving area R.

The gas supplier 8 is a device that is provided so as to penetrate the lid portion 2c and is connected to a supply source (not shown) of atmosphere-forming gas (for example, hydrocarbon gas) through a pipe (not shown) in an outer area of the lid portion 2c. The end part (the lower end part) of the gas supplier 8 penetrates the thermal insulator lid 3c1 of the upper thermal insulator 3c and is disposed in the receiving area R.

The first exhaust pipe 9 is arranged so as to diagonally extend upward and radially outward from the lid portion 2c and is disposed so as to communicate with a space between the lid portion 2c and the upper thermal insulator 3c, and the end (the end opposite to the lid portion 2c) of the first exhaust pipe 9 is connected to a vacuum pump (not shown). The second exhaust pipe 10 is inserted into the first exhaust pipe 9 so that the end (the end opposite to the upper thermal insulator 3c) of the second exhaust pipe 10 is disposed at an intermediate position of the first exhaust pipe 9. The second exhaust pipe 10 is provided so as to penetrate the lid portion 2c and the thermal insulator lid 3c1 of the upper thermal insulator 3c and to communicate with the receiving area R. The outer diameter of part of the second exhaust pipe 10 positioned close to the first exhaust pipe 9 is formed to be sufficiently less than the inner diameter of the first exhaust pipe 9, whereby the second exhaust pipe 10 is configured not to close the first exhaust pipe 9. The first and second exhaust pipes 9 and 10 are connected to the vacuum pump and are configured to forcibly exhaust the inside of the heating chamber 2 using the vacuum pump.

The stirrer 11 is fixed to the lid portion 2c and includes a drive portion 11a configured of a motor or the like and a stirring blade 11c attached to the drive portion 11a through a drive shaft 11b to be positioned under the drive portion 11a. The drive shaft 11b is disposed so as to penetrate the thermal insulator lid 3c1 of the upper thermal insulator 3c. The stirring blade 11c is attached to the lower end part of the drive shaft 11b and thereby is disposed in an upper area inside the receiving area R. The stirrer 11 stirs gas inside the receiving area R through rotational motion of the stiffing blade 11c and thus uniformizes the temperature and the gas concentration inside the receiving area R.

When the heat treatment apparatus 1 performs heating treatment for the treatment object W, first, the treatment object W is set on the mounting table 4 and is loaded into the heating chamber 2. Next, the power supplier 6 energizes the heaters 5, whereby the receiving area R is heated to an intended temperature. In addition, the vacuum pump (not shown) is operated, whereby the heating chamber 2 is depressurized through the first and second exhaust pipes 9 and 10. The depressurization of the heating chamber 2 may be performed before the energization for the heaters 5.

Then, when the heating chamber 2 has a depressurized atmosphere with an intended temperature, the stirrer 11 is driven, thereby the stirring blade 11c is rotated, and as needed, the gas supplier 8 supplies the atmosphere-forming gas. Accordingly, heating treatment is performed on the treatment object W. At this time, for example, when the temperature of the lower section of the receiving area R is lower than that of the upper section thereof, the electric power to be supplied from the lower heater-power supplier 6a is increased, whereby the quantity of heat generation of the lower heaters 5a is increased. Accordingly, the quantity of heat applied to the lower section of the receiving area R is increased, and thus it is possible to cause the temperature of the receiving area R to be uniform.

After the heating treatment is performed in this way for a predetermined period of time, the heating using the heaters 5 is stopped. Then, the depressurization using the vacuum pump is also stopped, and the treatment object W is unloaded from the inside of the heating chamber 2. Thereafter, a new treatment object W is set inside the heating chamber 2, and the above operations are repeated, whereby the heating treatment can also be performed on the new treatment object W.

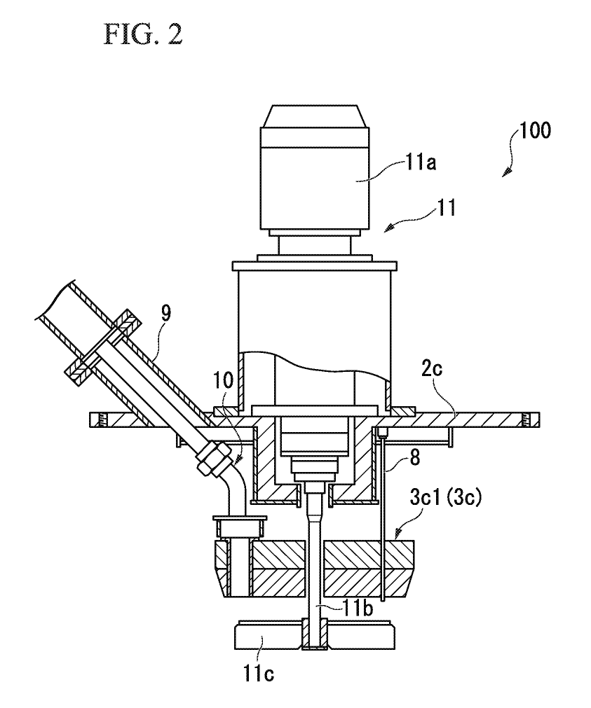

In the heat treatment apparatus 1 of this embodiment, as shown in FIG. 2, the lid portion 2c of the heating chamber 2 is united (integrally connected) with the thermal insulator lid 3c1 that is part of the upper thermal insulator 3c of the thermal insulator 3. In addition, the lid portion 2c is further united (integrally connected) with the gas supplier 8, the first exhaust pipe 9, the second exhaust pipe 10 and the stirrer 11. Hereinafter, a section configured by uniting these components is referred to as a lid section 100. As shown in FIG. 2, in the lid section 100, the thermal insulator lid 3c1 is integrally connected to the lid portion 2c of the heating chamber 2 through the gas supplier 8 and the second exhaust pipe 10. In order to connect the thermal insulator lid 3c1 and the lid portion 2c to each other, another connecting member may be employed together with the gas supplier 8 and the second exhaust pipe 10 or may be employed in place of the gas supplier 8 and the second exhaust pipe 10.

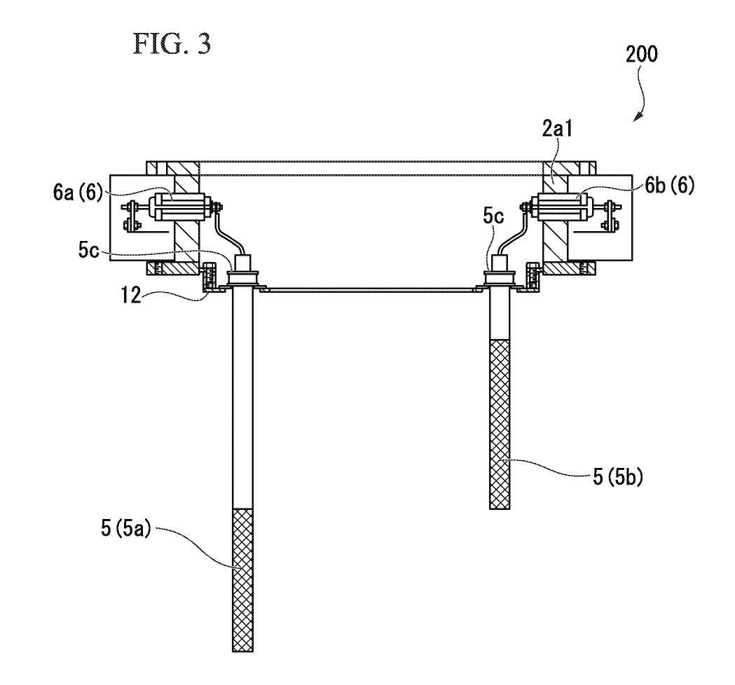

In the heat treatment apparatus 1 of this embodiment, as shown in FIG. 3, the heaters 5, the upper part 2a1 of the side wall portion 2a, the supporting member 12 and the power supplier 6 are united, whereby a heater section 200 is configured. In addition, the components (the lower part 2a2 of the side wall portion 2a, the bottom portion 2b of the heating chamber 2, the lower thermal insulator 3a and the side thermal insulator 3b of the thermal insulator 3, the frame 3c3 of the upper thermal insulator 3c, the mounting table 4 and the maffle plate 7) other than the components of the lid section 100 and the heater section 200 configure a base section 300 (refer to FIGS. 1, 4 and 5).

The lid portion 2c and the side wall portion 2a (the upper part 2a1) are fastened together using the bolts 30 shown in FIG. 1, whereby the lid section 100 is fixed to the base section 300 through the heater section 200. In addition, when the bolts 30 are removed therefrom, the lid section 100 can be separated from the heater section 200 and can be detached from the base section 300. That is, in the heat treatment apparatus 1 of this embodiment, the lid portion 2c of the heating chamber 2 and the thermal insulator lid 3c1 that is part of the upper thermal insulator 3c of the thermal insulator 3 as one unit are configured to be attachable to and detachable from the base section 300.

The upper part 2a1 and the lower part 2a2 of the side wall portion 2a are fastened together using the bolts 20 shown in FIG. 1, whereby the heater section 200 is fixed to the base section 300. In addition, the heater section 200 is united with the lid section 100 by being fastened using the bolts 30. The heater section 200 can be detached from the base section 300 by removing the bolts 20 and can be detached from the lid section 100 by removing the bolts 30. That is, in the heat treatment apparatus 1 of this embodiment, the heaters 5 are configured to be attachable to and detachable from the lid section 100 (namely, the lid portion 2c and the thermal insulator lid 3c1).

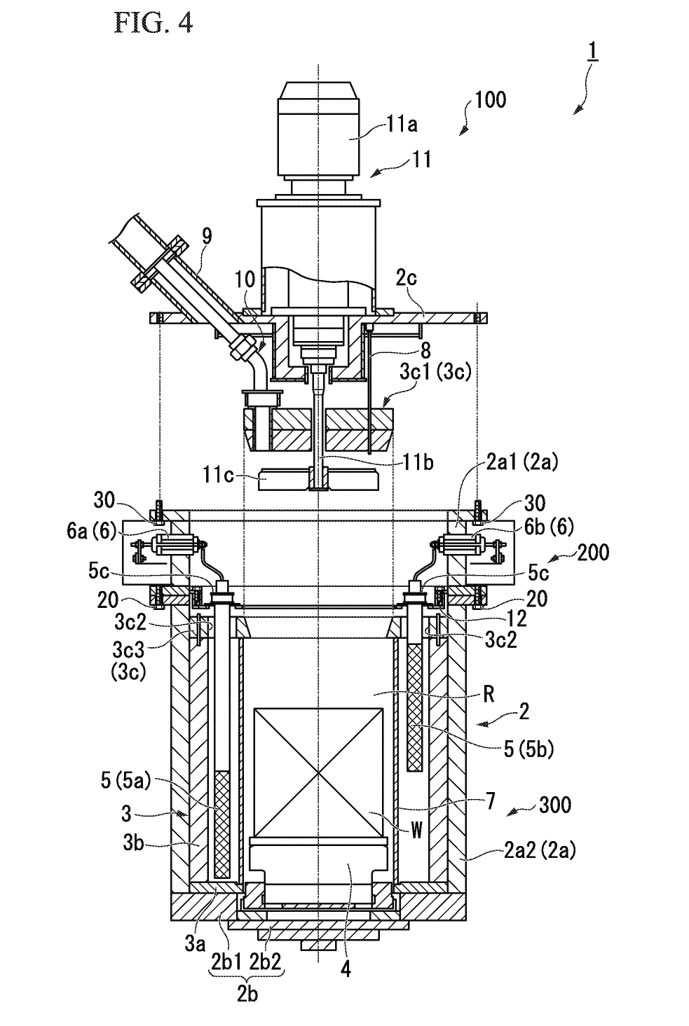

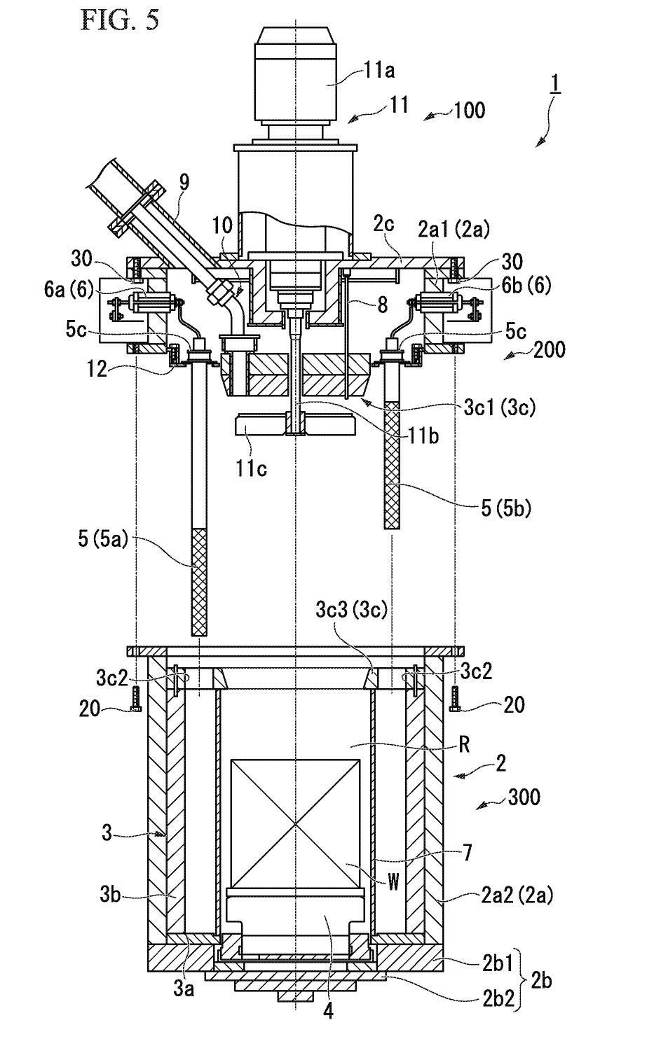

FIG. 4 is an exploded cross-sectional view showing a state where only the lid section 100 is detached from the base section 300 and the heater section 200 fixed to the base section 300. FIG. 5 is an exploded cross-sectional view showing a state where the heater section 200 and the lid section 100 that are united are detached from the base section 300.

As shown in FIGS. 4 and 5, in the heat treatment apparatus 1 of this embodiment, in either of a case where only the lid section 100 is detached from the base section 300 (and the heater section 200) and a case where the lid section 100 and the heater section 200 are detached together from the base section 300, the lid portion 2c and the thermal insulator lid 3c1 as one unit are detached from the base section 300, and the inside of the thermal insulator 3 is exposed upward. That is, the thermal insulator lid 3c1 of this embodiment is configured to be detached from the frame 3c3 of the upper thermal insulator 3c at the same time that the lid portion 2c is detached from the side wall portion 2a of the heating chamber 2. Therefore, the detaching work of the thermal insulator lid 3c1 need not be individually carried out, and it is possible to easily perform inspections or the like of the inner wall of the thermal insulator 3, the mounting table 4 and the maffle plate 7 from above.

As shown in FIG. 5, the lid section 100 and the heater section 200 are detached from the base section 300 in a state where the heaters 5 are united to the lid portion 2c, whereby the heaters 5 can be easily taken out of the heating chamber 2.

Since the circumferential surface of the thermal insulator lid 3c1 is provided with the tapered surface and the frame 3c3 is provided with the tapered surface matching the above circumferential surface, when the thermal insulator lid 3c1 is attached to the frame 3c3, the lid 3c1 can be easily inserted into the inside of the frame 3c3 and can be easily fitted into the frame 3c3. Therefore, even if it is difficult to perform accurate positioning between the thermal insulator lid 3c1 and the frame 3c3 in a horizontal direction when the lid portion 2c of the heating chamber 2 is attached to the side wall portion 2a, since the above tapered surfaces are provided therein, only when the lid portion 2c is merely moved downward in the vertical direction (a liner direction, the central axis direction of the side wall portion) and is caused to contact the side wall portion 2a, the fitting of the thermal insulator lid 3c1 to the frame 3c3 can be finished. Thus, the attachment work of the lid portion 2c and the lid 3c1 can be simplified.

According to the heat treatment apparatus 1 of this embodiment having the above configuration, part of the upper thermal insulator 3c serving as the ceiling of the thermal insulator 3 surrounding the receiving area R for the treatment object W is the thermal insulator lid 3c1, and the thermal insulator lid 3c1 is united to the lid portion 2c of the heating chamber 2. In addition, the lid portion 2c of the heating chamber 2 is configured to be attachable to and detachable from the side wall portion 2a of the heating chamber 2. Therefore, when the lid portion 2c of the heating chamber 2 is detached from the side wall portion 2a, the thermal insulator lid 3c1 is also detached from the frame 3c3 at the same time of the detachment of the lid portion 2c. Consequently, it is possible to perform inspections or the like of the inside of the thermal insulator 3 only through the detaching work of the lid portion 2c of the heating chamber 2. Thus, according to the heat treatment apparatus 1 of this embodiment, it is possible to perform work such as inspection of the inside of the thermal insulator 3.

In the heat treatment apparatus 1 of this embodiment, the upper thermal insulator 3c serving as the ceiling of the thermal insulator 3 includes the circular plate-shaped thermal insulator lid 3c1 whose circumferential surface has the tapered surface and the frame 3c3 having the tapered surface that contacts the circumferential surface of the thermal insulator lid 3c1 so as to overlap the circumferential surface. Therefore, when the thermal insulator lid 3c1 is made to contact the frame 3c3 (that is, when the lid section 100 is attached to the base section 300), since the thermal insulator lid 3c1 contacts the frame 3c3 through a wide area, it is possible to limit the atmosphere-forming gas (for example, hydrocarbon gas) from leaking out of the receiving area R. Consequently, it is possible to limit soot or the like from attaching to members positioned outside of the receiving area R.

The heat treatment apparatus 1 of this embodiment includes the heaters 5 that are disposed inside the heating chamber 2 and are configured to be attachable to and detachable from the lid portion 2c and the thermal insulator lid 3c1. Therefore, the heaters 5 can be detached from the base section 300 at the same time that the lid section 100 is detached therefrom. Consequently, it is possible to easily perform inspection or replacement of the heaters 5.

Hereinbefore, although a suitable embodiment of the present disclosure is described with reference to the drawings, the present disclosure is not limited to the above embodiment. The shape, the combination or the like of each component shown in the above embodiment is an example, and addition, omission, replacement, and other modifications of a configuration based on a design request or the like can be adopted within the scope of the present disclosure.

For example, in the above embodiment, a configuration is described in which only part of the upper thermal insulator 3c of the thermal insulator 3 is the thermal insulator lid 3c1. However, the present disclosure is not limited to this configuration, and a configuration may be adopted in which the entire upper thermal insulator 3c of the thermal insulator 3 is a thermal insulator lid. In this case, the thermal insulator lid (the upper thermal insulator) may be configured to be supported by the side thermal insulator 3b and configured to be attachable to and detachable from the side thermal insulator 3b, and the entire upper thermal insulator may be integrally connected to the lid portion 2c of the heating chamber 2. That is, the upper thermal insulator may be detached from the side thermal insulator at the same time that the lid portion 2c is detached from the side wall portion 2a.

In the above embodiment, a configuration is adopted in which the thermal insulator lid 3c1 and the frame 3c3 are allowed to contact each other through the tapered surfaces capable of overlapping each other. However, the present disclosure is not limited to this configuration, and for example, stepped portions capable of fitting each other may be provided in the thermal insulator lid 3c1 and the frame 3c3, and the thermal insulator lid 3c1 and the frame 3c3 may be configured to contact each other so that the stepped portions fit each other and surfaces thereof overlap each other. In this case, it is also possible to limit the atmosphere-forming gas (for example, hydrocarbon gas) from leaking out of the receiving area R.

In the above embodiment, the thermal insulator lid 3c1 is formed into a circular plate shape, and the circumferential surface thereof has the tapered surface. However, the present disclosure is not limited thereto, and the thermal insulator lid 3c1 may be a plate member (for example, a plate member whose shape in plan view is polygonal) other than circular plates. In this case, the peripheral edge surface of the plate member may be provided with a tapered surface or the like whose diameter gradually decreases downward.

In the above embodiment, the heating chamber 2 and the thermal insulator 3 are formed into cylindrical shapes. However, the present disclosure is not limited thereto, and these components may be formed into shapes other than cylindrical shapes, for example, rectangular tube shapes.

In the above embodiment, the lid portion 2c is provided in the upper part of the heating chamber 2 (the heat treatment chamber), and the thermal insulator lid 3c1 is provided in the upper part of the thermal insulator 3. However, the present disclosure is not limited thereto, and the installed positions of the lid portion and the thermal insulator lid may be changed in accordance with the conveyance direction of a treatment object. For example, in a case where the treatment object is conveyed into the heating chamber in the left-and-right direction, the lid portion may be provided so as to be attachable to and detachable from the side portion of the heating chamber, and the thermal insulator lid may be provided so as to be attachable to and detachable from the side portion of the thermal insulator and may be united to the lid portion. In a case where the treatment object is conveyed into the heating chamber from below, the lid portion may be provided as to be attachable to and detachable from the bottom portion of the heating chamber, and the thermal insulator lid may be provided so as to be attachable to and detachable from the bottom portion of the thermal insulator and may be united to the lid portion. In these cases, part of the heating chamber (the heat treatment chamber) other than the lid portion corresponds to the heat treatment chamber body, and part of the thermal insulator other than the thermal insulator lid corresponds to the thermal insulator body. In addition, the lid portion may be provided so as to range over surfaces (for example, upper and side surfaces) of the heating chamber, and the thermal insulator lid may be provided so as to range over surfaces (for example, upper and side surfaces) of the thermal insulator.

In the above embodiment, an example is described in which the present disclosure is applied to the heat treatment apparatus 1. However, the present disclosure is not limited thereto and can be applied to a vacuum-carburizing furnace or the like.

### INDUSTRIAL APPLICABILITY

The present disclosure can be applied to a heat treatment apparatus that performs heating treatment for a treatment object inside a heating chamber (a heat treatment chamber) including a thermal insulator.

1. A heat treatment apparatus comprising:
a heat treatment chamber that performs heating treatment for a treatment object thereinside; and
a thermal insulator disposed inside the heat treatment chamber and surrounding a receiving area for the treatment object;
wherein the heat treatment chamber includes a heat treatment chamber body and a lid portion configured to be attachable to and detachable from the heat treatment chamber body,
wherein the thermal insulator includes a thermal insulator body and a thermal insulator lid configured to be attachable to and detachable from the thermal insulator body, and
wherein the thermal insulator lid is united to the lid portion.

2. The heat treatment apparatus according to claim 1,
wherein part of the heat treatment chamber body is a side wall portion of the heat treatment chamber,
wherein the lid portion is configured to be attachable to and detachable from an upper part of the side wall portion,
wherein the thermal insulator includes a ceiling disposed on the inside of the lid portion of the heat treatment chamber, and
wherein the thermal insulator lid is at least part of the ceiling.

3. The heat treatment apparatus according to Claim I,
wherein the thermal insulator lid is formed into a plate shape whose edge surface has a tapered surface, and
wherein the thermal insulator body includes a frame having a tapered surface that contacts the edge surface of the thermal insulator lid so as to overlap the edge surface.

4. The heat treatment apparatus according to claim 2,
wherein the thermal insulator lid is formed into a plate shape whose edge surface has a tapered surface, and
wherein the ceiling includes a frame having a tapered surface that contacts the edge surface of the thermal insulator lid so as to overlap the edge surface.

5. The heat treatment apparatus according to claim 3,
wherein the thermal insulator lid is formed into a circular plate shape whose circumferential surface has the tapered surface.

6. The heat treatment apparatus according to claim 4,
wherein the thermal insulator lid is formed into a circular plate shape whose circumferential surface has the tapered surface.

7. The heat treatment apparatus according to claims 1, further comprising
a heater disposed inside the heat treatment chamber and configured to be attachable to and detachable from the lid portion and the thermal insulator lid.

8. The heat treatment apparatus according to claims 2, further comprising
a heater disposed inside the heat treatment chamber and configured to be attachable to and detachable from the lid portion and the thermal insulator lid.

9. The heat treatment apparatus according to claims 3, further comprising
a heater disposed inside the heat treatment chamber and configured to be attachable to and detachable from the lid portion and the thermal insulator lid.

10. The heat treatment apparatus according to claims 4, further comprising
a heater disposed inside the heat treatment chamber and configured to be attachable to and detachable from the lid portion and the thermal insulator lid.

11. The heat treatment apparatus according to claims 5, further comprising
a heater disposed inside the heat treatment chamber and configured to be attachable to and detachable from the lid portion and the thermal insulator lid.

12. The heat treatment apparatus according to claims 6, further comprising
a heater disposed inside the heat treatment chamber and configured to be attachable to and detachable from the lid portion and the thermal insulator lid.
